(19) United States
(12) Patent Application Publication
(10) Pub. No.: US 2014/0188658 A1
(43) Pub. Date: Jul. 3, 2014

(54) AUTO DISPLAY OF A PRODUCT LOCATION MAP ON A MOBILE DEVICE BASED ON DEVICE CONTEXT

(71) Applicants: Hong Li, El Dorado Hills, CA (US); Mark H. Price, Placitas, NM (US); Taeho Kgil, Beaverton, OR (US); Eddie Ed Balthasar, Folosm, CA (US); Anand Rajan, Beaverton, OR (US)

(72) Inventors: Hong Li, El Dorado Hills, CA (US); Mark H. Price, Placitas, NM (US); Taeho Kgil, Beaverton, OR (US); Eddie Ed Balthasar, Folosm, CA (US); Anand Rajan, Beaverton, OR (US)

(21) Appl. No.: 13/995,987

(22) PCT Filed: Dec. 21, 2011
(86) PCT No.: PCT/US11/66513

§ 371 Date: Mar. 20, 2014

(51) Int. Cl. G06Q 30/06

(52) U.S. Cl. CPC G06Q 30/0639; G06Q 30/0633
USPC 705/26.8

(57) ABSTRACT

Generally, this disclosure describes a method and system for providing product mapping on a mobile device based on device context. A method may include receiving product location data based on a context of a mobile device, wherein the product location data includes an available product location for each available product that corresponds to a desired product in a shopping list of desired products; and displaying a map of a store that sells one or more available products, wherein the store is related to the context and the map includes a product location indicator corresponding to each available product location configured to allow a user to find each available product that corresponds to a respective desired product in the store.

### FIELD

This disclosure relates to providing a product location map, more particularly to product location mapping on a mobile device using device context.

### BACKGROUND

When a shopper enters a store, he/she may not know a location of each product on his/her shopping list. The shopper may search for each product. This searching may be time-consuming and may not always be successful. The shopper may try to find a member of the store staff to inquire about the location(s) of the product(s) on the shopping list. The shopper may be unable to find a staff person and/or the staff person, once found, may not know the location(s) of the product(s). Shopping carts at some stores may include a list of products available in the store (e.g., on sale or located in a particular aisle of the store) but this list is typically unrelated to the shopper's shopping list. As a result, the shopper may spend more time searching and may be unable to complete his/her shopping in a timely fashion.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 illustrates a product mapping system consistent with various embodiments of the present disclosure;

FIG. 2A illustrates a system that includes one exemplary embodiment of a product locator consistent with various embodiments of the present disclosure;

FIG. 2B illustrates another exemplary embodiment of a product locator consistent with various embodiments of the present disclosure;

FIG. 3 illustrates a flowchart of exemplary operations of a mobile device consistent with an embodiment of the present disclosure; and

FIG. 4 illustrates a flowchart of exemplary operations of a product locator consistent with an embodiment of the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure describes a method and system for providing product mapping on a mobile device based on device context. As used herein, device context corresponds to any information that may be used to characterize a situation of the device. Device context may include, but is not limited to, mobile device location, a distance between the mobile device and a store (e.g., device proximity) and/or recognition that a shopping list has been entered into the mobile device. The method and system are configured to provide a map of a store to a user. The store may be related to the device context of the mobile device. For example, the mobile device may be located relatively near or in the store. The map may include location indicators for each available product that corresponds to a desired product in a shopping list. The user may provide (enter) the shopping list into a mobile device. The mobile device is configured to provide the shopping list to a product locator associated with the store and to receive corresponding product location data for the store from the product locator. The product location data may include a location for each product available in the store that corresponds to a desired product on the shopping list. The location of each available product may then be indicated on the map of the store displayed on the mobile device. The user may then efficiently find the desired product(s) in the store that are on his/her shopping list. Thus, product location data based on device context may be provided to the mobile device. The product location data may correspond to locations of available desired products in a store related to the device context (e.g., the mobile device is in or near the store).

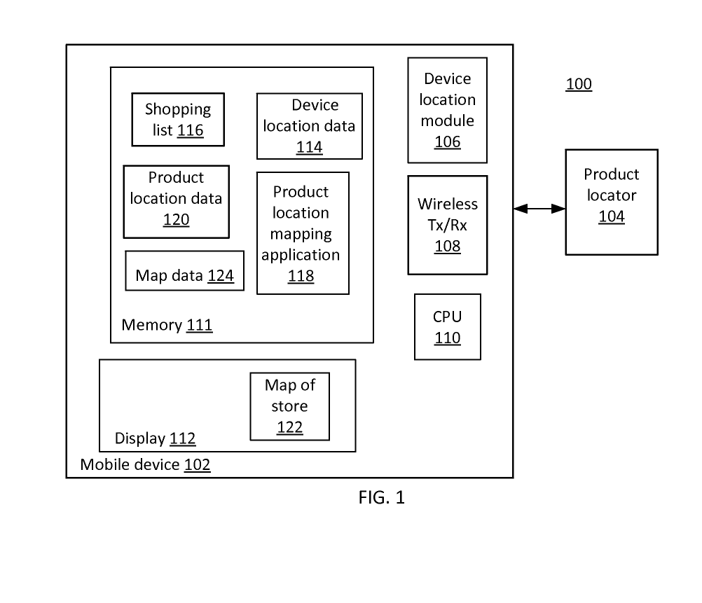

FIG. 1 illustrates a product mapping system 100 consistent with various embodiments of the present disclosure. The system 100 generally includes a mobile device 102 and a product locator 104. “Mobile device” as used herein means any handheld computing device, including, but not limited to, mobile telephones, smartphones, tablet computers, notebook computers, ultraportable computers, ultramobile computers, netbook computers, subnotebook computers, personal digital assistants, enterprise digital assistants, mobile internet devices and personal navigation devices. The product locator may be physically located in the store (e.g., an in-store computer application configured to process and transmit product location data) or it may be located remote from the store (e.g., an Internet-based web service application associated with the store), as described herein.

The mobile device 102 may include a device location module 106, a wireless transmitter/receiver (Tx/Rx) 108, a processor CPU 110, memory 111 and display 112. The device location module 106 is configured to receive a location signal and to determine a location of the mobile device 102 based on the location signal. The location of the mobile device 102 may be stored in the memory 111 as device location data 114. For example, the device location module 106 may be a GPS (Global Positioning System) module configured to determine the location based on a plurality of satellite signals. In another example, the device location module 106 may be configured to receive the location signal from a store when the mobile device is outside the store near the store (e.g., near an entrance) or inside the store.

Wireless Tx/Rx 108 is configured to transmit and receive one or more wireless radio signals that comply and/or are compatible with one or more communication protocols. As used herein, wireless radio signals and/or communication protocols include but are not limited to RFID (Radio-frequency identification), Bluetooth, Wi-Fi, 3G, 4G and/or other communication protocols. Mobile device 102 may be configured to communicate with product locator 104 via one or more of these communication protocols. For example, relatively near field communication protocols (e.g., RFID, Bluetooth) may be used when the mobile device 102 is relatively near the product locator 104. In another example, communication protocols configured for relatively more distant communication (e.g., Wi-Fi, 3G, 4G) may be utilized when the mobile device 102 is relatively more distant from the product locator 104.

CPU 110 is configured to perform operations associated with one or more applications on mobile device 102. Display 112 is configured to display a map of a store 122. The map may include product location indicator(s) for available products(s) that correspond to desired product(s) on the shopping list, as described herein.

Memory 111 may include the device location data 114, a shopping list 116, a product location application 118, product location data 120 and map data 124. Mobile device 102 is configured to receive the shopping list 116 and to store the shopping list 116 in memory 111. The shopping list 116 may include a list of one or more desired products that a user wishes to find in the store. The user may enter the list of products and the list may then be stored as shopping list 116.

The product location mapping application 118 is configured to communicate with the product locator 104 in order to provide the store map (including location indicators for desired and available product(s)) to a user. The product location mapping application 118 is configured to receive, store, process, and/or transmit the shopping list based on device context, to receive product location data and to provide the store map to the user. The product location mapping application 118 is configured to communicate with the product locator 104 via wireless Tx/Rx 108. The communications protocol may depend on a location of the product locator, as described herein. For example, product location mapping application 118 may initiate communication with the product locator 104 in response to the user entering the shopping list 116. In another example, the communication may be initiated when the mobile deice approaches the store, e.g., based on device context after the shopping list has been entered. In another example, communication may be initiated in response to a user selecting, e.g., an icon displayed on display 112 of mobile device 102.

The product location mapping application 118 is configured to provide the shopping list 116 to the product locator 104. The product locator 104 is configured to provide location data 120 to the mobile device 102 in response to receiving the shopping list 116. The product location data 120 includes a location in the store for each available product that corresponds to a desired product on the shopping list 116. The product locator 104 may provide map data 124 for the store to mobile device 102. The map data 124 may be used to display a map of the store 122 including available product location indicator(s) on mobile device 102, e.g., on display 112. The map of the store 122 may include directions from a current location of the mobile device to the location(s) of one or more of the available products in the store.

Thus, a user may enter a shopping list into a mobile device that may be provided to product locator 104. Product locator 104 may then provide product location data 120 to mobile device 102 based on device context. A map of a store 122 including product location indicators for each available product may then be displayed to the user on display 112. The product locator 104 may be itself located in the store and/or may be an application associated with the store that is actually executing in a remote server.

It should be noted that not all desired products will necessarily be available in the store (target store). Further, one or more products may be available both in the target store and in other stores in proximity (proximity stores) to the target store. It is contemplated that a product mapping system may also be configured to provide product location indicators on a map that includes the target store as well as one or more proximity stores. A list of proximity stores may be provided to the mobile device by, e.g., a community-based collaboration service. For example, the shopping list, the context of the mobile device (e.g., the location of the mobile device and/or target store identifier) may be provided to the collaboration service. Other members of the community may then provide name(s) and location(s) of one or more proximity stores that may sell one or more of the desired products. In another example, a proximity application included in the mobile device may be configured to find and select proximity stores that sell one or more of the desired products. The proximity stores selected may be determined based on the location of the mobile device and/or the desired products in the shopping list (i.e., device context).

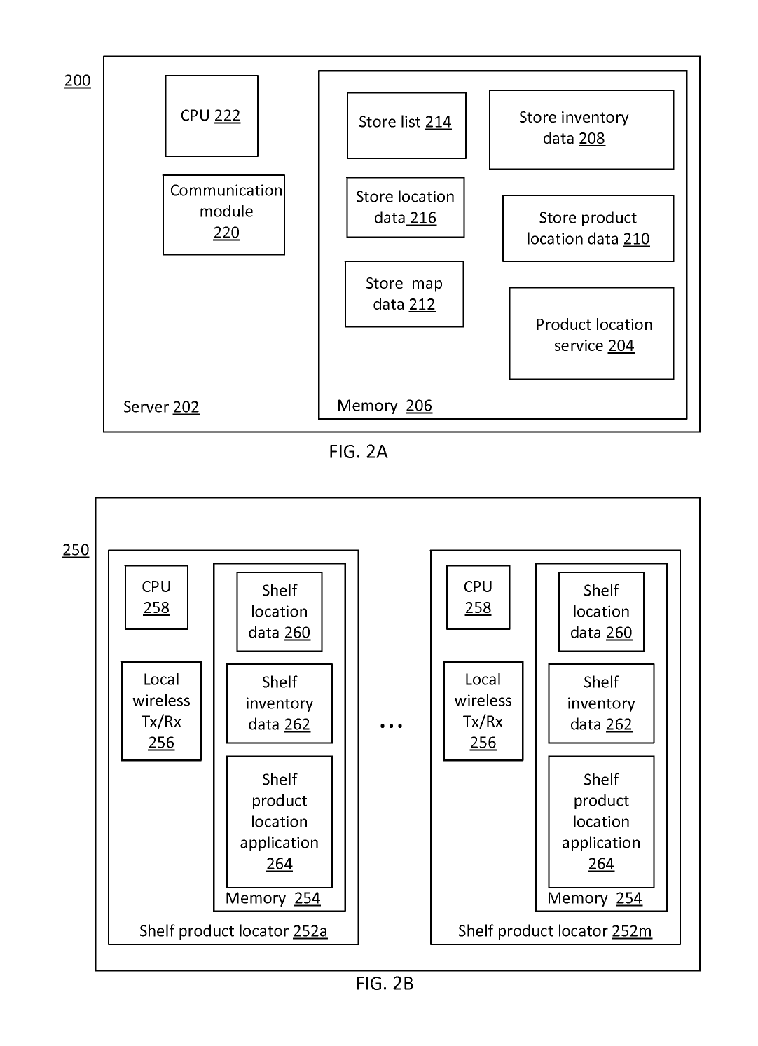

FIG. 2A illustrates a system 200 that includes one embodiment of a product locator (e.g., product location service 204) consistent with the present disclosure. Product location service 204 is configured to receive the shopping list from mobile device 102 and to provide product location data to the mobile device 102, as described herein. Product location service 204 may be included in a server 202, e.g., may be stored in server memory 206. Server 202 may be a dedicated server (or servers) associated with one or more store(s) or may be included in a cloud service (managed by a cloud service provider) that includes a plurality of servers. For example, product location service 204 may be a local application hosted in-store when the server 202 is located in the store. In another example, product location service 204 may be a web-based on-line application hosted by the store's on-line service. In both examples, the product location service 204 may be accessed by the mobile device 102 (and product location mapping application 118) when the mobile device 102 is located near or in the store.

The product location service 204 may be configured to communicate with the mobile device 102 via communications module 220. Communications module 220 may include wireless communication capability, e.g., Wi-Fi, 3G and/or 4G. Communication module 220 may be configured to connect server 202 to a network, via, e.g., a network adapter. Server 202 may include at least one processor CPU 222 configured to perform operations associated with one or more applications.

Product location service 204 is configured to receive a shopping list including a list of desired products from a mobile device as described herein, and to determine which of the desired products are available in the store. For example, the server 202 may include store inventory data 208 that includes a list of products available in the store and the product location service 204 may determine which products are available based on this list. Store product location data 210 may include a location for each product included in store inventory data 208. Product location service 204 may then determine a location of each available product that corresponds to a desired product based on store product location data 210. Product location service is configured to provide product location data and store map data 212 to the mobile device 102. Store map data 212 may include a store map for one or more stores. In this manner, location(s) of available desired product(s) may be determined by the product location service 204 and may be provided to the mobile device 102 so that product location indicators may be displayed on a store map to a user, as described herein.

In one embodiment, the server 202 may include store inventory data 208, store product location data 210 and store map data 212 for a plurality of stores. The plurality of stores may be listed in a store list 214 included in server 202 and locations of each store may be included in store location data 216. In this embodiment, a location of the mobile device may also be provided to the product location service 204 and may be utilized to select a particular store, identified by store location, that corresponds to the mobile device location. Product availability and product location may then be determined as described herein for the selected store.

Thus, in the embodiment illustrated in FIG. 2A, the product locator may be a product location service that is physically hosted in-store or is web-based and hosted remotely. In both cases, the product location service is configured to provide product location data for available products that correspond to desired products listed in a shopping list provided by a mobile device based on the context of the mobile device.

FIG. 2B illustrates a product locator 250 consistent with another embodiment of the present disclosure. The product locator 250 includes a plurality of shelf product locators 252a, . . . , 252m. Each shelf product locator 252a, . . . , 252m may include memory 254, a local wireless transmitter/receiver 256 and a processor CPU 258. Each shelf product locator is configured to provide product location data for available product(s) on an associated shelf that correspond to desired product(s) include in a shopping list, e.g., shopping list 116.

The memory 254 is configured to store shelf location data 260, shelf inventory data 262 and shelf product location application 264. CPU 258 is configured to perform the operations of shelf product location application 264. Shelf location data 260 may include location data corresponding to a shelf associated with a respective shelf product locator 252a, . . . , or 252m.

The shelf location data 260 is configured to provide a location of the respective shelf in the store and corresponds to available product location for one or more available products that may be on the shelf. Shelf inventory data 262 may include an available product identifier for each available product that is on the shelf and a number corresponding to a quantity of each available product. For example, for a shelf that has five DVD players, the shelf inventory data 262 may include an identifier that corresponds to DVD players and a quantity corresponding to five. It should be noted that one shelf may hold a plurality of available products and the shelf inventory data 262 may then include a plurality of available product identifiers and a plurality of associated quantities.

The shelf product location application 264 is configured to provide the shelf (and therefore available product) location in response to receiving at least a portion of a shopping list from a mobile device, e.g., mobile device 102. The shelf product location application 264 may determine whether an available product listed in the shelf inventory data 262 corresponds to a desired product listed in the shopping list and may respond with shelf location data 260 if the shelf's associated available product corresponds to the desired product.

Each shelf product locator 252a, . . . , 252m may be configured to receive at least a portion of the shopping list 116 from mobile device 102 via local wireless transmitter/receiver 256. For example, local wireless transmitter/receiver may be configured to communicate using RFID and/or Bluetooth. If an available product corresponds to a desired product, the shelf product location application 264 may be configured to respond with an available product identifier and a shelf location corresponding to the location of the available product.

Thus, when mobile device 102 is in the store, mobile device 102 may communicate with the plurality of shelf product locators 252a, . . . , 252m to determine a location of desired available products in the store. Each shelf location and available product indicator may then be displayed on the store map on the display of the mobile device. The user may then find the available desired products according to the map, without searching and without input from a store staff member.

FIGS. 2A and 2B thus provide two exemplary embodiments of product locators consistent with the present disclosure. The product location service 204 may be hosted on a server and may be configured to communicate with the mobile device via, e.g., Wi-Fi and/or 3G. The product location service 204 may be configured to provide product location data for each available product that corresponds to a desired product according to the shopping list. The shelf product locators 252a, . . . , 252m are configured to provide product location data for available product that is located on one or more associated shelves in the store.

It should be noted that, although the shelf product locators have been described as communicating with the mobile device, in an example, the shelf product locators may be configured to communicate with an in-store server. The in-store server may then host an application configured to provide communication of shopping list and/or product location data between the shelf product locators and the mobile device. In this example, communication with the mobile device may or may not include RFID and/or Bluetooth.

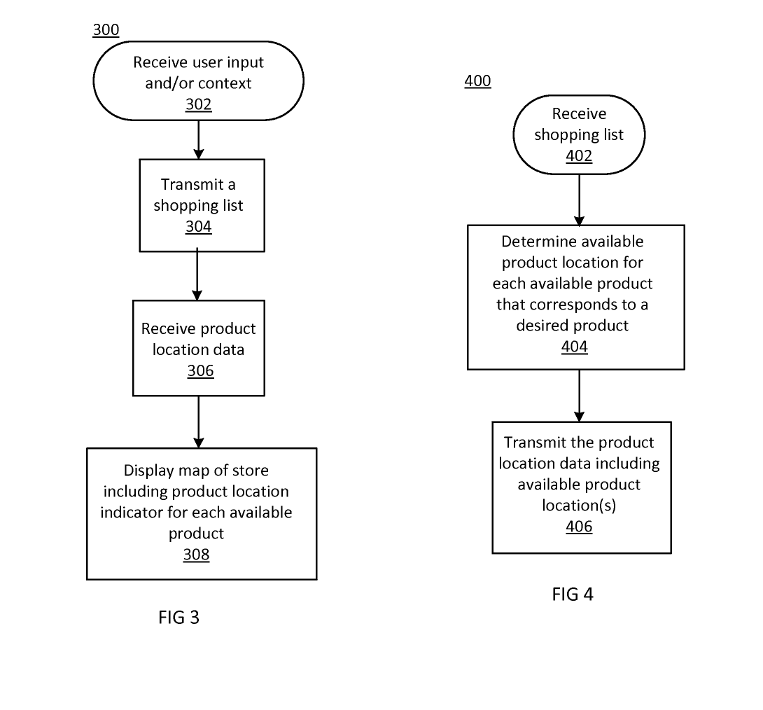

FIG. 3 illustrates a flowchart 300 of exemplary operations consistent with an embodiment of the present disclosure. The operations of flow chart 300 may be performed by a mobile device, e.g., mobile device 102. In particular, flowchart 300 depicts exemplary operations configured to provide product mapping on a mobile device based on device context. The operations of flow chart 300 may be initiated 302 in response to receiving a user input by the mobile device and/or device context. For example, the operations may begin when a user enters the shopping list into the mobile device. In another example, the operations of flow chart 300 may begin in response to the user selecting a product mapping icon displayed on the mobile device. In this example, the shopping list may be stored in the mobile device. In another example, the operations may be initiated based on context. Context may include the location of the mobile device, device proximity to a store and/or whether a shopping list is stored. Continuing with this example, a mobile device with a stored shopping list located near a store may be sufficient context to initiate the operations of flowchart 300.

Operation 304 may include transmitting. For example, the shopping list may be provided to a product locator. The product locator is configured to provide product location data including an available product location for each available product that corresponds to a desired product. The product location data may be received at operation 306. Operation 308 may include displaying a map of a store including a product location indicator for each available product. Thus, a store map including product location indicator(s) for each available product corresponding to a desired product may be displayed. The user may then efficiently find each desired available product using the displayed map.

FIG. 4 is a flow chart 400 illustrating exemplary operations of an available product mapping system consistent with the present disclosure. The operations of flow chart 400 may be performed by a product locator. The operations of flow chart 400 may begin with operation 402. Operation 402 includes receiving a shopping list. For example, the shopping list may be received from a mobile device. The shopping list may include a list of desired products that a user wishes to find in a store. Available product location(s) may be determined for each available product that corresponds to a desired product at operation 404. Operation 406 may include transmitting the product location data to the mobile device.

Thus, a user may provide (enter) a list of desired products, i.e., a shopping list, to a mobile device. The shopping list may be provided to a product locator. The product locator may be physically located in the store, e.g., hosted in a server located in the store and/or associated with a shelf, or may be physically located elsewhere, e.g., hosted in a remote server. For example, the product locator may be included in a server that may be accessed via Wi-Fi, 3G, 4G, or the like. In another example, the product locator may include a plurality of shelf product locators configured to communicate locations of available products using, e.g., RFID and/or Bluetooth. The product locator is configured to determine an available product location for each available product that corresponds to a desired product based on device context. The product locator may then provide product location data to the mobile device. The mobile device is configured to display available desired product indicator(s) on a store map. The user may then efficiently find desired products based on the map.

While FIGS. 3 and 4 illustrate various operations according one embodiment, it is to be understood that not all of the operations depicted in FIGS. 3 and 4 are necessary for other embodiments. Indeed, it is fully contemplated herein that in other embodiments of the present disclosure, the operations depicted in FIGS. 3 and 4 and/or other operations described herein may be combined in a manner not specifically shown in any of the drawings, but still fully consistent with the present disclosure. Thus, claims directed to features and/or operations that are not exactly shown in one drawing are deemed within the scope and content of the present disclosure.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical locations. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), magnetic or optical cards, or any type of media suitable for storing electronic instructions. Other embodiments may be implemented as software modules executed by a programmable control device. The storage medium may be non-transitory.

While the foregoing is prided as exemplary system architectures and methodologies, modifications to the present disclosure are possible. For example, memory, e.g., mobile device memory 111, server memory 206 and/or shelf product locator memory 254 may comprise one or more of the following types of memory: semiconductor firmware memory, programmable memory, non-volatile memory, read only memory, electrically programmable memory, random access memory, flash memory, magnetic disk memory, and/or optical disk memory. Either additionally or alternatively system mobile device memory 111, server memory 206 and/or shelf product locator memory 254 may comprise other and/or later-developed types of computer-readable memory.

Mobile device 102 may be configured to communicate with a network and/or product locator 104 using a variety of communication protocols. The communications protocols may include but are not limited to wireless communications protocols, such as Wi-Fi, Bluetooth, 3G, 4G, RFID and/or other communication protocols. The communications protocols may comply and/or be compatible with other related Internet Engineering Task Force (IETF) standards.

The Wi-Fi protocol may comply or be compatible with the 802.11 standards published by the Institute of Electrical and Electronics Engineers (IEEE), titled “IEEE 802.11-2007 Standard, IEEE Standard for Information Technology-Telecommunications and Information Exchange Between Systems-Local and Metropolitan Area Networks-Specific Requirements—Part 11: Wireless LAN Medium Access Control (MAC) and Physical Layer (PHY) Specifications” published, Mar. 8, 2007, and/or later versions of this standard.

The RFID communication signal and/or protocol may comply or be compatible with one or more RFID standards published by the International Standards Organization (ISO) and/or the International Electrotechnical Commission (IEC), including ISO/IEC 14443, titled: Identification cards—Contactless integrated circuit cards—Proximity cards, published in 2008; ISO/IEC 15693: Identification cards—Contactless integrated circuit cards—Vicinity cards, published in 2006, titled:; ISO/IEC 18000, titled: Information technology—Radio frequency identification for item management, published in 2008; and/or ISO/IEC 18092, titled: Information technology—Telecommunications and information exchange between systems—Near Field Communication—Interface and Protocol, published in 2004; and/or related and/or later versions of these standards.

The Bluetooth protocol may comply or be compatible with the 802.15.1 standard published by the IEEE, titled “IEEE 802.15.1-2005 standard, IEEE Standard for Information technology—Telecommunications and information exchange between systems—Local and metropolitan area networks—Specific requirements Part 15.1: Wireless Medium Access Control (MAC) and Physical Layer (PHY) Specifications for Wireless Personal Area Networks (W Pans)”, published in 2005, and/or later versions of this standard.

The 3G protocol may comply or be compatible with the International Mobile Telecommunications (IMT) standard published by the International Telecommunication Union (ITU), titled “IMT-2000”, published in 2000, and/or later versions of this standard. The 4G protocol may comply or be compatible with IMT standard published by the ITU, titled “IMT-Advanced”, published in 2008, and/or later versions of this standard.

Mobile device 102 may be capable of communicating with a network and/or product locator 104 using a selected packet switched network communications protocol. One exemplary communications protocol may include an Ethernet communications protocol which may be capable permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in March 2002 and/or later versions of this standard. Alternatively or additionally, mobile device 102 may be capable of communicating with a network and/or product locator 104, using an X.25 communications protocol. The X.25 communications protocol may comply or be compatible with a standard promulgated by the International Telecommunication Union-Telecommunication Standardization Sector (ITU-T). Alternatively or additionally, mobile device 102 may be capable of communicating with a network and/or product locator 104, using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, mobile device 102 may be capable of communicating with a network and/or product locator 104, using an Asynchronous Transfer Mode (ATM) communications protocol. The ATM communications protocol may comply or be compatible with an ATM standard published by the ATM Forum titled “ATM-MPLS Network Interworking 1.0” published August 2001, and/or later versions of this standard. Of course, different and/or after-developed connection-oriented network communication protocols are equally contemplated herein.

“Circuitry”, as used in any embodiment herein, may comprise, for example, singly or in any combination, hardwired circuitry, programmable circuitry, state machine circuitry, and/or firmware that stores instructions executed by programmable circuitry. An application (“app”), as used in any embodiment herein, may be embodied as circuitry. The circuitry may be embodied as an integrated circuit, such as an integrated circuit chip.

Thus, the present disclosure provides a method and system for providing product mapping on a mobile device based on device context. A product mapping system consistent with the present disclosure is configured to provide a map of a store including product location indicators to a user of a mobile device based on device context (e.g., mobile device location). The mobile device is configured to receive a shopping list from a user and to communicate the shopping list to a product locator. The product locator may be located in the store and/or may be located remote from the store. The product locator is configured to receive the shopping list and to provide product location data to the mobile device based on device context as described herein.

According to one aspect there is provided a method. The method may include receiving product location data based on a context of a mobile device, wherein the product location data includes an available product location for each available product that corresponds to a desired product in a shopping list of desired products; and displaying a map of a store that sells one or more available products, wherein the store is related to the context and the map includes a product location indicator corresponding to each available product location configured to allow a user to find each available product that corresponds to a respective desired product in the store.

According to another aspect there is provided a system. The system may include a mobile device configured to receive product location data based on a context of the mobile device, wherein the product location data includes an available product location for each available product that corresponds to a desired product in a shopping list of desired products; and
display a map of a store that sells one or more available products, wherein the store is related to the context and the map includes a product location indicator corresponding to each available product location configured to allow a user to find each available product that corresponds to a respective desired product in the store.

According to another aspect there is provided a system. The system may include one or more storage mediums having stored thereon, individually or in combination, instructions that when executed by one or more processors result in the following operations including: receiving product location data based on a context of a mobile device, wherein the product location data includes an available product location for each available product that corresponds to a desired product in a shopping list of desired products; and displaying a map of a store that sells one or more available products, wherein the store is related to the context and the map includes a product location indicator corresponding to each available product location configured to allow a user to find each available product that corresponds to a respective desired product in the store.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

1-15. (canceled)

16. A method comprising:
receiving product location data based on a context of a mobile device, wherein the product location data comprises an available product location for each available product that corresponds to a desired product in a shopping list of desired products; and
displaying a map of a store that sells one or more available products, wherein the store is related to the context and the map comprises a product location indicator corresponding to each available product location configured to allow a user to find each available product that corresponds to a respective desired product in the store.

17. The method of claim 16, wherein the product location data is received in response to transmitting the shopping list.

18. The method of claim 16, further comprising:
determining the available product location for each available product that corresponds to a desired product.

19. The method of claim 16, further comprising:
determining the context of the mobile device, wherein the context comprises a location of the mobile device.

20. The method of claim 16, further comprising:
determining whether at least one desired product is available.

21. The method of claim 5, wherein the determining whether a desired product is available is based, at least in part, on store inventory data.

22. The method of claim 20, wherein the determining whether a desired product is available is based, at least in part, on shelf inventory data.

23. A system, comprising:
a mobile device configured to:
receive product location data based on a context of the mobile device, wherein the product location data comprises an available product location for each available product that corresponds to a desired product in a shopping list of desired products; and
display a map of a store that sells one or more available products, wherein the store is related to the context and the map comprises a product location indicator corresponding to each available product location configured to allow a user to find each available product that corresponds to a respective desired product in the store.

24. The system of claim 23, wherein the mobile device is further configured to determine the context, the context comprising a location of the mobile device.

25. The system of claim 23, further comprising a product locator associated with the store that sells the one or more available products, wherein the product locator is configured to provide the product location data to the mobile device.

26. The system of claim 25, wherein the product locator is configured to determine the available product location for each available product that corresponds to a desired product.

27. The system of claim 25, wherein the product locator comprises a product location service configured to determine whether at least one desired product is available.

28. The system of claim 25, wherein the product locator comprises a plurality of shelf product locators, at least one shelf product locator configured to determine whether at least one desired product is available on an associated shelf.

29. A system comprising one or more storage mediums having stored thereon, individually or in combination, instructions that when executed by one or more processors result in the following operations comprising:
receiving product location data based on a context of a mobile device, wherein the product location data comprises an available product location for each available product that corresponds to a desired product in a shopping list of desired products; and
displaying a map of a store that sells one or more available products, wherein the store is related to the context and the map comprises a product location indicator corresponding to each available product location configured to allow a user to find each available product that corresponds to a respective desired product in the store.

30. The system of claim 29, wherein the product location data is received in response to transmitting the shopping list.

31. The system of claim 29, wherein the instructions that when executed by one or more processors results in the following additional operations:
determining the available product location for each available product that corresponds to a desired product.

32. The system of claim 29, wherein the instructions that when executed by one or more processors results in the following additional operations:
determining the context of the mobile device, wherein the context comprises a location of the mobile device.

33. The system of claim 29, wherein the instructions that when executed by one or more processors results in the following additional operations:
determining whether at least one desired product is available.

34. The system of claim 33, wherein the determining whether a desired product is available is based, at least in part, on store inventory data.

35. The system of claim 33, wherein the determining whether a desired product is available is based, at least in part, on shelf inventory data.
